(19) United States
(12) Patent Application Publication
(10) Pub. No.: US 2017/0075545 A1
(43) Pub. Date: Mar. 16, 2017

(54) METHOD FOR OBTAINING A REGION OF CONTENT AND ELECTRONIC DEVICE SUPPORTING THE SAME

(71) Applicant: Samsung Electronics Co., Ltd., Gyeonggi-do (KR)

(72) Inventors: Shin Ho KIM, Gyeonggi-do (KR); Dong Ho YU, Gyeonggi-do (KR); Eun Seok HONG, Gyeonggi-do (KR)

(73) Assignee: Samsung Electronics Co., Ltd.

(21) Appl. No.: 15/233,418

(22) Filed: Aug. 10, 2016

(30) Foreign Application Priority Data
Sep. 10, 2015 (KR) 10-2015-0128131

(51) Int. Cl. G06F 3/0484; G06F 3/0488; G06F 3/0481

(52) U.S. Cl. CPC G06F 3/04845; G06F 3/04842; G06F 3/0481; G06F 3/0488

(57) ABSTRACT

An electronic device is provided. The electronic device includes a display, a memory configured to store at least one piece of content, and a processor electrically connected to the display and the memory, wherein the processor is configured to receive input events sequentially input to a screen of the display, output a content, select a partial region of the content based on input events within a specified time or at an interval, and display the partial region of the content different from a peripheral region of the screen.

### PRIORITY

This application claims priority under 35 U.S.C. §119(a) to Korean Patent Application Serial No. 10-2015-0128131, which was filed on Sep. 10, 2015, in the Korean Intellectual Property Office, the entire content of which is incorporated herein by reference.

### BACKGROUND

1. Field of the Disclosure

The present disclosure generally relates to a method of obtaining a content region.

2. Description of the Related Art

Electronic devices may output, to a display, a screen according to execution of content.

Conventional electronic devices provide a function of capturing the entire content execution screen in response to a user input.

### SUMMARY

Accordingly, an aspect of the present disclosure provides a content region obtaining method for selecting a content region desired by a user in a simplified manner and an electronic device supporting the same.

In accordance with another aspect of the present disclosure, an electronic device is provided. The electronic device includes a housing, a memory disposed within the housing and configured to store at least one piece of content, and a processor electrically connected to the memory to process at least one instruction stored in the memory, wherein the processor selects a partial region of the content based on input events sequentially input within a specified time or at an interval of less than a specified time, and obtains and displays the selected partial region of the content according to a specified condition.

In accordance with another aspect of the present disclosure, a content obtaining method is provided. The content obtaining method includes displaying content, receiving input events sequentially input to a display, on which the content is displayed, within a specified time or at an interval of less than a specified time, and selecting a partial region of the content based on the received input events and obtaining and displaying the selected partial region of the content according to a specified condition.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating an operation environment of an electronic device which supports a content obtaining function, according to an embodiment of the present disclosure;

FIG. 2 is a block diagram illustrating a configuration of a processor related to a content acquisition function, according to an embodiment of the present disclosure;

FIG. 3 is a flowchart illustrating a connection-based content obtaining method, according to an embodiment of the present disclosure;

FIG. 4 is a flowchart illustrating a content obtaining method, according to an embodiment of the present disclosure;

FIG. 5 is a flowchart illustrating a content obtaining method, according to another embodiment of the present disclosure;

FIG. 6 is a diagram illustrating a screen interface related to a content obtaining function, according to an embodiment of the present disclosure;

FIG. 7 is a diagram illustrating a screen interface related to a content obtaining function, according to another embodiment of the present disclosure;

FIG. 8 is a diagram illustrating a screen interface related to a content obtaining function, according to another embodiment of the present disclosure;

FIG. 9 is a diagram illustrating a screen interface related to a content obtaining function, according to another embodiment of the present disclosure;

FIG. 10 is a diagram illustrating a screen interface related to a content obtaining function, according to another embodiment of the present disclosure;

FIG. 11 is a block diagram illustrating an electronic device, according an embodiment of the present disclosure; and

FIG. 12 is a block diagram illustrating a program module, according to an embodiment of the present disclosure.

### DETAILED DESCRIPTION

Hereinafter, various embodiments of the present disclosure will be described in detail with reference to the accompanying drawings. However, it should be understood that the present disclosure is not limited to specific embodiments, but rather includes various modifications, equivalents and/or alternatives of the embodiments of the present disclosure. Regarding description of the drawings, similar reference numerals may refer to similar elements.

The terms “have”, “may have”, “include”, “may include”, “comprise”, and the like used herein indicate the existence of a corresponding feature (e.g., a number, a function, an operation, or an element) and do not exclude the existence of an additional feature.

The terms “A or B”, “at least one of A and/or B”, or “one or more of A and/or B” may include all possible combinations of items listed together. For example, the terms “A or B”, “at least one of A and B”, or “at least one of A or B” may indicate all the cases of (1) including at least one A, (2) including at least one B, and (3) including at least one A and at least one B.

The terms “first”, “second”, and the like used herein may modify various elements regardless of the order and/or priority thereof, and are used only for distinguishing one element from another element, without limiting the elements. For example, “a first user device” and “a second user device” may indicate different user devices regardless of the order or priority. For example, without departing the scope of the present disclosure, a first element may be referred to as a second element and vice versa.

It will be understood that when a certain element (e.g., a first element) is referred to as being “operatively or communicatively coupled with/to” or “connected to” another element (e.g., a second element), the certain element may be coupled to the other element directly or via another element (e.g., a third element). However, when a certain element (e.g., a first element) is referred to as being “directly coupled” or “directly connected” to another element (e.g., a second element), there may be no intervening element (e.g., a third element) between the element and the other element.

The term “configured (or set) to” as used herein may be interchangeably used with the terms, for example, “suitable for”, “having the capacity to”, “designed to”, “adapted to”, “made to”, or “capable of”. The term “configured (or set) to” may not necessarily have the meaning of “specifically designed to”. In some cases, the term “device configured to” may indicate that the device “may perform” together with other devices or components. For example, the term “processor configured (or set) to perform A, B, and C” may represent a dedicated processor (e.g., an embedded processor) for performing a corresponding operation, or a general-purpose processor (e.g., a CPU or an application processor) for executing at least one software program stored in a memory device to perform a corresponding operation.

The terminology herein is only used for describing specific embodiments and is not intended to limit the scope of other embodiments. The terms of a singular form may include plural forms unless otherwise specified. The terms used herein, including technical or scientific terms, have the same meanings as understood by those of ordinary skill in the art. Terms defined in general dictionaries, among the terms used herein, may be interpreted as having meanings that are the same as, or similar to, contextual meanings defined in the related art, and should not be interpreted in an idealized or overly formal sense unless otherwise defined explicitly. Depending on the case, even the terms defined herein should not be such interpreted as to exclude various embodiments of the present disclosure.

An electronic device according to various embodiments of the present disclosure may include at least one of a smartphone, a tablet personal computer (PC), a mobile phone, a video telephone, an electronic book reader, a desktop PC, a laptop PC, a netbook computer, a workstation, a server, a personal digital assistant (PDA), a portable multimedia player (PMP), a motion picture experts group (MPEG-1 or MPEG-2) audio layer 3 (MP3) player, a mobile medical device, a camera, or a wearable device. The wearable device may include at least one of an accessory-type device (e.g., a watch, a ring, a bracelet, an anklet, a necklace, glasses, a contact lens, a head-mounted device (HDM)), a textile- or clothing-integrated-type device (e.g., an electronic apparel), a body-attached-type device (e.g., a skin pad or a tattoo), or a bio-implantable-type device (e.g., an implantable circuit).

According to an embodiment of the present disclosure, an electronic device may be a home appliance. The home appliance may include at least one of, for example, a television (TV), a digital versatile disc (DVD) player, an audio player, a refrigerator, an air conditioner, a cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ or PlayStation™), an electronic dictionary, an electronic key, a camcorder, or an electronic picture frame.

According to an embodiment of the present disclosure, an electronic device may include at least one of various medical devices (e.g., various portable medical measurement devices (e.g., a blood glucose measuring device, a heart rate measuring device, a blood pressure measuring device, a body temperature measuring device, and the like), a magnetic resonance angiography (MRA), a magnetic resonance imaging (MRI), a computed tomography (CT), a scanner, an ultrasonic device, and the like), a navigation device, a global navigation satellite system (GNSS), an event data recorder (EDR), a flight data recorder (FDR), a vehicle infotainment device, electronic equipment for vessels (e.g., a navigation system, a gyrocompass, and the like), avionics, a security device, a head unit for a vehicle, an industrial or home robot, an automatic teller machine (ATM), a point of sales (POS) terminal, or an Internet of Things (IoT) device (e.g., a light bulb, various sensors, an electric or gas meter, a sprinkler, a fire alarm, a thermostat, a streetlamp, a toaster, exercise equipment, a hot water tank, a heater, a boiler, and the like).

According to an embodiment of the present disclosure, an electronic device may include at least one of a part of furniture or a building/structure, an electronic board, an electronic signature receiving device, a projector, or a measuring instrument (e.g., a water meter, an electricity meter, a gas meter, a wave meter, and the like). An electronic device may be one or more combinations of the above-mentioned devices. An electronic device may be a flexible device. An electronic device is not limited to the above-mentioned devices, and may include new electronic devices with the development of new technology.

Hereinafter, an electronic device according to an embodiment of the present disclosure will be described with reference to the accompanying drawings. The term “user” as used herein may refer to a person who uses an electronic device or may refer to a device (e.g., an artificial intelligence device) that uses an electronic device.

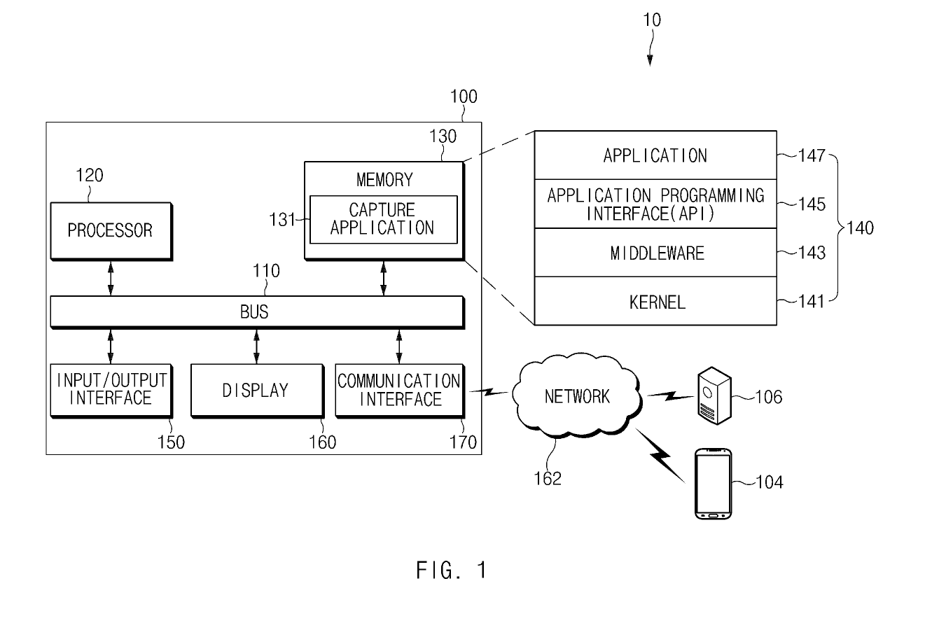

FIG. 1 is a diagram illustrating an operation environment of an electronic device which supports a content obtaining function according to an embodiment of the present disclosure.

Referring to FIG. 1, an electronic device operating environment 10 includes an electronic device 100, an external electronic device 104, a server 106, and a network 162.

The network 162 may support establishment of a communication channel between the electronic device 100 and the external electronic device 104 or between the electronic device 100 and the server 106. The network 162 may provide a path for transmitting content stored in the electronic device 100 to the external electronic device 104 or the server 106.

The external electronic device 104 may establish a short-range communication channel to the electronic device 100. According to an embodiment of the present disclosure, the external electronic device 104 may be a device which is substantially the same as, or similar to, the electronic device 100. The external electronic device 104 may transmit content to the electronic device 100 according to a setting or a user input. The content provided by the external electronic device 104 may be output to a display 160 of the electronic device 100. Furthermore, the external electronic device 104 may output content provided by the electronic device 100. The external electronic device 104 may capture a part of content displayed on a display in response to an input event (e.g., sequentially input touch events), and may perform at least one of displaying, storing, or transmitting the captured part.

The server 106 may establish a communication channel to the electronic device 100 via the network 162. The server 106 may provide content such as a web page to the electronic device 100 in response to a request from the electronic device 100. The content provided by the server 106 may be output through the display 160 of the electronic device 100. Furthermore, the content provided by the server 106 may be partially obtained by the electronic device 100 and may be displayed, stored, or transmitted.

The electronic device 100 may obtain, based on sequential input events, at least a part of content being output to the display 160 in response to operation (or execution) of a capture application. The electronic device 100 may display at least a part of obtained content on the display 160, or may store it in a memory 130, or may transmit it to the external electronic device 104 or the server 106 according to a setting or a user input.

The electronic device 100 includes a bus 110, a processor 120, the memory 130, an input/output interface 150, the display 160, and a communication interface 170. In an embodiment of the present disclosure, at least one of the foregoing elements may be omitted or another element may be added to the electronic device 100. The electronic device 100 may include a housing for surrounding or accommodating at least a portion of the foregoing elements.

The bus 110 may include a circuit for connecting the above-mentioned elements 120 to 170 to each other and transferring communications (e.g., control messages and/or data) among the above-mentioned elements.

The processor 120 may include at least one of a central processing unit (CPU), an application processor (AP), or a communication processor (CP). The processor 120 may perform data processing or an operation related to communication and/or control of at least one of the other elements of the electronic device 100.

According to various embodiments of the present disclosure, the processor 120 may perform a function related to acquisition of content. For example, if content is output to the display 160, the processor 120 may activate a capture application 131 automatically or according to a setting. The processor 120 may determine whether an input event which is input while the content is displayed on the display 160 satisfies a specified condition. For example, the processor 120 may determine whether input events are input in a certain order with respect to a specified content location. The processor 120 may obtain at least a partial region of the content based on the sequential input events, if sequential input of the input events is completed and the specified condition (e.g., elapse of a specified time or occurrence of an event indicating completion of content acquisition) is satisfied. The processor 120 may output at least a partial region of obtained content to the display 160, or may store it in the memory 130, or may transmit it to the external electronic device 104 according to a setting or a user input.

In relation to partial acquisition of content, the memory 130 may store the capture application 131. The capture application 131, for example, may be executed when content is output to the display 160. Alternatively, the capture application 131 may be activated in response to a user input. The capture application 131, for example, may include a set of instructions (or routines, functions, templates, classes, and the like) set (or configured) to receive input events sequentially input. Furthermore, the capture application 131 may include a set of instructions set to obtain at least a part of displayed content based on input events, a set of instructions set to output at least a part of obtained content to a separate screen or a popup window, or a set of instructions set to store at least a part of obtained content or transmit it to the external electronic device 104 or server 106. According to various embodiments of the present disclosure, the capture application 131 may include a set of instruction set to output a capture guide corresponding to sequential input events, a set of instructions set to adjust the capture guide in response to an additional input event, or a set of instructions set to adjust a content acquisition region in response to input event modification.

The memory 130 may include a volatile memory and/or a nonvolatile memory. The memory 130 may store instructions or data related to at least one of the other elements of the electronic device 100. According to an embodiment of the present disclosure, the memory 130 may store software and/or a program 140. The program 140 includes, for example, a kernel 141, a middleware 143, an application programming interface (API) 145, and/or an application program (or an application) 147. At least a portion of the kernel 141, the middleware 143, or the API 145 may be referred to as an operating system (OS).

The kernel 141 may control or manage system resources (e.g., the bus 110, the processor 120, the memory 130, and the like) used to perform operations or functions of other programs (e.g., the middleware 143, the API 145, or the application program 147). Furthermore, the kernel 141 may provide an interface for allowing the middleware 143, the API 145, or the application program 147 to access individual elements of the electronic device 100 in order to control or manage the system resources.

The middleware 143 may serve as an intermediary so that the API 145 or the application program 147 communicates and exchanges data with the kernel 141. Furthermore, the middleware 143 may handle one or more task requests received from the application program 147 according to a priority order. For example, the middleware 143 may assign at least one application program 147 a priority for using the system resources (e.g., the bus 110, the processor 120, the memory 130, and the like) of the electronic device 100. For example, the middleware 143 may handle the one or more task requests according to the priority assigned to the at least one application, thereby performing scheduling or load balancing with respect to the one or more task requests.

The API 145, which is an interface for allowing the application 147 to control a function provided by the kernel 141 or the middleware 143, may include, for example, at least one interface or function (e.g., instructions) for file control, window control, image processing, character control, and the like. The application 147 may include various applications related to operation of the capture application 131. For example, in the case where the capture application 131 is designed to obtain only at least a part of content, the application 147 may include an application having a function of displaying obtained content on the display 160 or storing the obtained content in the memory 130 and an application having a function of transmitting the obtained content to an external electronic device. According to various embodiments of the present disclosure, the application 147 may include a messenger application corresponding to a messenger program related to processing of the obtained content.

The input/output interface 150 may serve to transfer an instruction or data input from a user or another external device to other element(s) of the electronic device 100. Furthermore, the input/output interface 150 may output instructions or data received from other element(s) of the electronic device 100 to the user or another external device. According to various embodiments of the present disclosure, the input/output interface 150 may include an input device such as a touch panel, a physical key, an optical key, a keypad, and the like. The input/output interface 150 may generate, in response to a user input, an input event for selecting content stored in the memory 130 or content provided by the server 106 or the external electronic device 104, an input event (e.g., sequential input events) for obtaining a part of selected content, or an input event for giving instructions to perform at least one of displaying, storing, or transmitting of obtained content. The generated input event corresponding to the user input may be transferred to the processor 120, and may be converted into an instruction corresponding to the type of the input event.

According to various embodiments of the present disclosure, the input/output interface 150 may include an audio input/output device such as a speaker, a receiver, an earphone, a microphone, and the like. The input/output interface 150 may output audio information related to output of content, audio information (e.g., a sound effect or a guide message corresponding to a touch input) related to acquisition of content, or audio information related to processing of obtained content. Outputting the above-mentioned audio information may be omitted according to a setting.

The display 160 may include, for example, a liquid crystal display (LCD), a light-emitting diode (LED) display, an organic light-emitting diode (OLED) display, a microelectromechanical systems (MEMS) display, or an electronic paper display. The display 160 may present various content (e.g., a text, an image, a video, an icon, a symbol, and the like) to the user. The display 160 may include a touch screen, and may receive a touch, gesture, proximity or hovering input from an electronic pen or a part of a body of the user.

According to various embodiments of the present disclosure, the display 160 may output at least one screen or user interface related to a content acquisition function. The display 160 may output a selected or set content playback screen. The display 160 may output a capture guide that indicates an acquisition region on the content playback screen. A size, a location, or a shape of the capture guide may be changed in response to a user input.

The communication interface 170 may set communications between the electronic device 100 and the external electronic device 104 or the server 106. For example, the communication interface 170 may be connected to the network 162 through wired or wireless communications so as to communicate with the external device 104 or the server 106. The wireless communications may employ at least one of cellular communication protocols such as long-term evolution (LTE), LTE-advance (LTE-A), code division multiple access (CDMA), wideband CDMA (WCDMA), universal mobile telecommunications system (UMTS), wireless broadband (WiBro), or global system for mobile communications (GSM). Furthermore, the wireless communications may include, for example, short-range communications. The short-range communications may include at least one of wireless fidelity (Wi-Fi), Bluetooth, near field communication (NFC), global navigation satellite system (GNSS), and the like. The GNSS may include, for example, at least one of global positioning system (GPS), global navigation satellite system (GLONASS), Beidou navigation satellite system (Beidou), or Galileo, the European global satellite-based navigation system according to a use area or a bandwidth. Hereinafter, the term “GPS” and the term “GNSS” may be used interchangeably with one another. The wired communications may include at least one of universal serial bus (USB), high definition multimedia interface (HDMI), recommended standard 232 (RS-232), plain old telephone service (POTS), and the like. The network 162 may include at least one of telecommunications networks, for example, a computer network (e.g., a LAN or WAN), the Internet, or a telephone network.

According to various embodiments of the present disclosure, the communication interface 170 may transmit at least a part of obtained content to the external electronic device 104 or the server 106 in response to control by the processor 120. The communication interface 170 may transmit obtained content to an external electronic device for which a short-range communication channel is to be established, in response to control by the processor 120.

According to an embodiment of the present disclosure, the server 106 may include a group of one or more servers. A portion or all of operations performed in the electronic device 100 may be performed in one or more other electronic devices (e.g., the external electronic device 104 or the server 106). In the case where the electronic device 100 should perform a certain function or service automatically or in response to a request, the electronic device 100 may request at least a portion of functions related to the function or service from the external electronic device 104 or the server 106 instead of or in addition to performing the function or service for itself. The other electronic device, the external electronic device 104 or the server 106, may perform the requested function or additional function, and may transfer a result of the performance to the electronic device 100. The electronic device 100 may intactly use, or additionally process, a received result to provide the requested function or service. To this end, for example, a cloud computing technology, a distributed computing technology, or a client-server computing technology may be used.

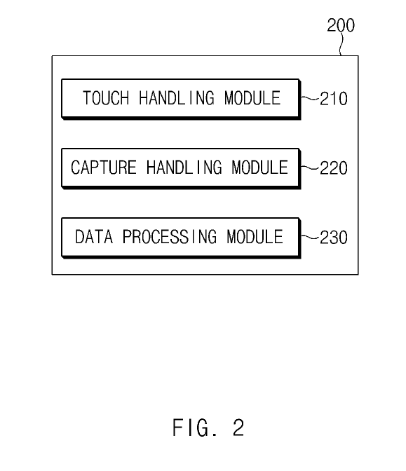

FIG. 2 is a block diagram illustrating a configuration of a processor related to a content acquisition function, according to an embodiment of the present disclosure.

Referring to FIG. 2, a processor 200 (e.g., the processor 120) according to an embodiment of the present disclosure includes a touch handling module 210, a capture handling module 220, and a data processing module 230. At least one of the touch handling module 210, the capture handling module 220, or the data processing module 230 may include at least one processor. Accordingly, each of the touch handling module 210, the capture handling module 220, and the data processing module 230 may correspond to a processor. Alternatively, one processor may include at least one of the touch handling module 210, the capture handling module 220, or the data processing module 230.

The touch handling module 210, for example, may activate the capture application 131 when playback of specified content is requested or playback of content is requested. According to various embodiments of the present disclosure, the capture application 131 may be provided as a capture function of a specified application. For example, a gallery application, a web browser application, a document editing application, and the like, may have a capture function. In this case, if the gallery application or the web browser application is activated, the electronic device 100 may activate a capture function automatically or in response to a user input (e.g., selection of an icon or a menu related to execution of a capture function). The touch handling module 210 may handle an input event of the electronic device 100.

According to various embodiments of the present disclosure, the touch handling module 210 may receive input events input according to a specified condition after a content screen is output to the display 160. The touch handling module 210 may group input events received within a certain time or input events that have occurred at an interval less than a specified time. For example, if a second input event is received within a specified time after a first input event is received, the touch handling module 210 may group the first input event and the second input event as one group. Furthermore, if a third input event is received within a specified time after the first input event and the second input event is received within a specified time, the touch handling module 210 may group the first to third input events as one group. If a movement (e.g., a drag event) of the grouped input events occurs after the grouped input events are received, the touch handling module 210 may receive trajectory values according to the movement, and may add the trajectory values to the grouped input events. The touch handling module 210 may transfer the grouped input events to the capture handling module 220. If an input event is not received within a specified time, the touch handling module 210 may handle a function according to the types of previous input events.

The capture handling module 220 may obtain a part of content based on grouped input events received from the touch handling module 210. According to an embodiment of the present disclosure, the capture handling module 220 may output a capture guide corresponding to the input events. The capture guide may be changed according to the number, locations, or movement of the input events. For example, if locations (or location values) of a first input event and a second input event are received, the capture handling module 220 may output the capture guide corresponding to a certain shape on the display (e.g., a polygon such as a quadrangle and the like, a circle, or an ellipse) including the two location values. The capture handling module 220 may obtain at least a part of an image or a text of a region indicated by the capture guide if a specified condition is satisfied (e.g., elapse of a specified time or occurrence of an input event for capture).

According to an embodiment of the present disclosure, the capture handling module 220 may receive grouped input events corresponding to the first input event, the second input event, and a drag event. The capture handling module 220 may output the capture guide shaped as a free curve corresponding to a figure including an occurrence point of the first input event, a start point of the second input event, a trajectory of a drag, and an end point of the drag. If a specified condition (e.g., release of a touch and drag gesture) is satisfied, the capture handling module 220 may obtain a part of content included in a region of the capture guide shaped as a free curve.

According to an embodiment of the present disclosure, the capture handling module 220 may receive a plurality of input events that have occurred within a specified time or have occurred at an interval less than a specified time. The capture handling module 220 may output a multi-point capture guide formed by connecting location values of the received input events by at least one of a straight line or a curved line. The capture handling module 220 may obtain a part of content included within the multi-point capture guide according to whether a specified condition is satisfied.

According to various embodiments of the present disclosure, in the case where a text is disposed on a region determined by grouped input events, the capture handling module 220 may select a text disposed on a region indicated by input events. The capture handling module 220 may obtain a text on a region automatically or in response to a user input.

According to various embodiments of the present disclosure, the capture handling module 220 may receive, from the touch handling module 210, a value for adjusting a location of a specific input event. The capture handling module 220 may change at least one of the shape or size of the capture guide in response to location adjustment and may output the capture guide. As a specified condition is satisfied, the capture handling module 220 may obtain a content part or portion included in a location-adjusted captured guide.

The data processing module 230 may process a content part obtained by the capture handling module 220. For example, the data processing module 230 may output, to the display 160, a popup window or a new window including the content part only. When the popup window is output, a previous content screen may be displayed on a lower layer under the popup window. The popup window may be overlaid on the previous content screen. A displayed state of the previous content screen displayed on the lower layer may be different from that prior to the output of the popup window. For example, the previous content screen output together with the popup window may be decreased in brightness by a specified level.

The data processing module 230 may store an obtained content part in the memory 130. In this storing operation, the data processing module 230 may store the obtained content part in association with source content. For example, the data processing module 230 may store source content-related information as tag information for the obtained content part. According to various embodiments of the present disclosure, the data processing module 230 may transmit the obtained content part to the specified external electronic device 104, or the server 106, automatically or in response to a user input.

According to various embodiments of the present disclosure, an electronic device may include a housing, a memory disposed within the housing and configured to store at least one piece of content, and a processor electrically connected to the memory to process at least one instruction stored in the memory, wherein the processor may select a partial region of the content based on input events sequentially input within a specified time or at an interval less than a specified time, and may obtain and display the selected partial region of the content according to a specified condition.

According to various embodiments of the present disclosure, the processor may output a capture guide including at least a portion of input locations of a plurality of received input events.

According to various embodiments of the present disclosure, the processor may output the capture guide including the input locations of the plurality of received input events and a straight line or a curved line connecting adjacent input locations among the input location values.

According to various embodiments of the present disclosure, the processor may receive an additional input event corresponding to a location change of at least one of the plurality of input events, and may adjust a shape of the capture guide in response to the additional input event to output the capture guide.

According to various embodiments of the present disclosure, the processor may output, as a first capture guide, a figure including a location value of a first input event and a location value of a second input event input within a specified time as diagonally opposite corners.

According to various embodiments of the present disclosure, if a third input event is received while the first capture guide is output, the processor may output a second capture guide obtained by modifying the first capture guide in relation to an input location value of the third input event.

According to various embodiments of the present disclosure, the processor may output, as the second capture guide, a figure including the location value of the first input event, the location value of the second input event input within a specified time, and the location value of the third input events as corner location values.

According to various embodiments of the present disclosure, the processor may output the obtained partial region of the content to a popup window or a new window.

According to various embodiments of the present disclosure, the processor may output the obtained partial region of the content in a full screen.

According to various embodiments of the present disclosure, the processor may determine the type of content, and may differently output the capture guide corresponding to the plurality of received input events according to the type of content.

According to various embodiments of the present disclosure, the plurality of input events may include input events of touching and holding a touch screen.

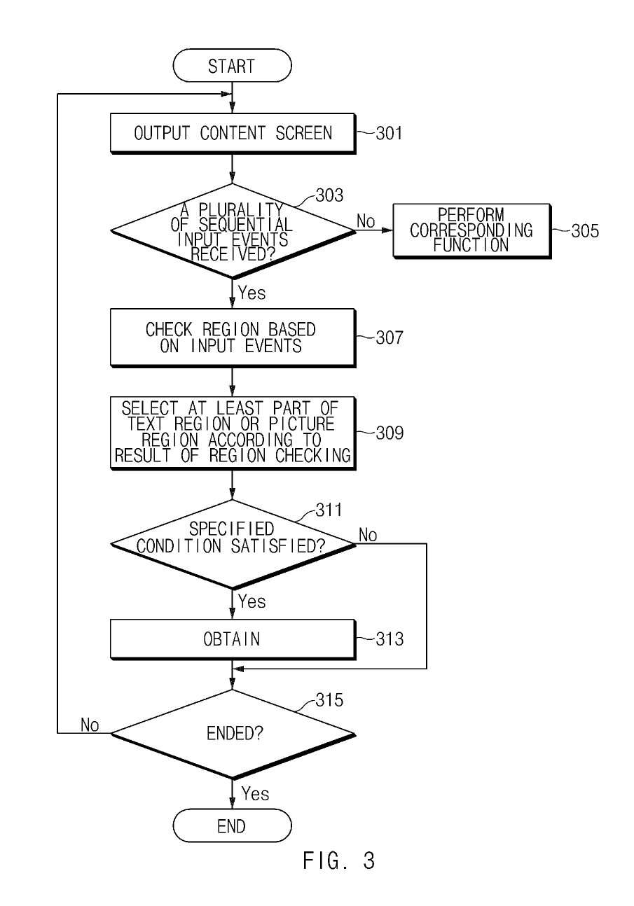

FIG. 3 is a flowchart illustrating a connection-based content obtaining method, according to an embodiment of the present disclosure.

Referring to FIG. 3, in operation 301, the processor 200 (or the processor 120) outputs a content screen. For example, if an event of requesting playback of specified content, an event of executing a specified application, or an event of requesting access to the server 106 occurs, the processor 200 may output a playback screen of selected content or a screen of a web page received through access to the server 106 as the content screen.

In operation 303, the processor 200 determines whether a plurality of sequential input events are received. For example, the processor 200 may determine whether a plurality of input events which are consecutively input within a specified time interval are received. If a plurality of sequential input events are not received, the processor 200 may perform a function corresponding to an input event type in operation 305.

If a plurality of sequential input events are received, the processor 200 checks a region based on the input events in operation 307. In relation to this operation, the processor 200 may receive a location (or location values, or occurrence points of the input events on the display) of the input events. The processor 200 may determine a certain region including the location values of the input events. The above-mentioned sequential input events may include a plurality of touchdown and hold events. Alternatively, the sequential input events may include input events of sequentially touching (e.g., tapping) a certain region of the display 160.

In operation 309, the processor 200 selects at least a part of a text region or a picture (or image) region according to a result of region checking. For example, the processor 200 may determine whether an image or a text is disposed on a checked certain region. In the case of a region on which a text is displayed, the processor 200 may obtain texts included within the checked region. In the case of a region on which an image is displayed, the processor 200 may cut and obtain an image included within the checked region.

In operation 311, the electronic device 200 determines whether a specified condition is satisfied. For example, the processor 200 may determine whether a specified time has elapsed since acquisition of a content part or whether a gesture which indicates completion of content acquisition or an event such as selection of a specific icon has occurred. If the specified condition is not satisfied, operation 313 may be skipped. For example, in the case where the input events are removed without being maintained for a specified time or an event of cancelling the acquisition of the content part occurs, the processor 200 may skip operation 313.

If the specified condition is satisfied, the processor 200 handles (obtains) the acquisition of the content part in operation 313. Furthermore, the processor 200 may perform at least one of displaying, storing, or transmitting of the obtained content part. In operation 315, the processor 200 determines whether an event related to function termination occurs. If the event related to function termination does not occur, the process returns to operation 301 so that the processor 200 may repeat operation 301 and the subsequent operations. When the event related to function termination occurs, the processor 200 ends a function related to acquisition of a content part. Alternatively, the processor 200 may stop outputting the content screen.

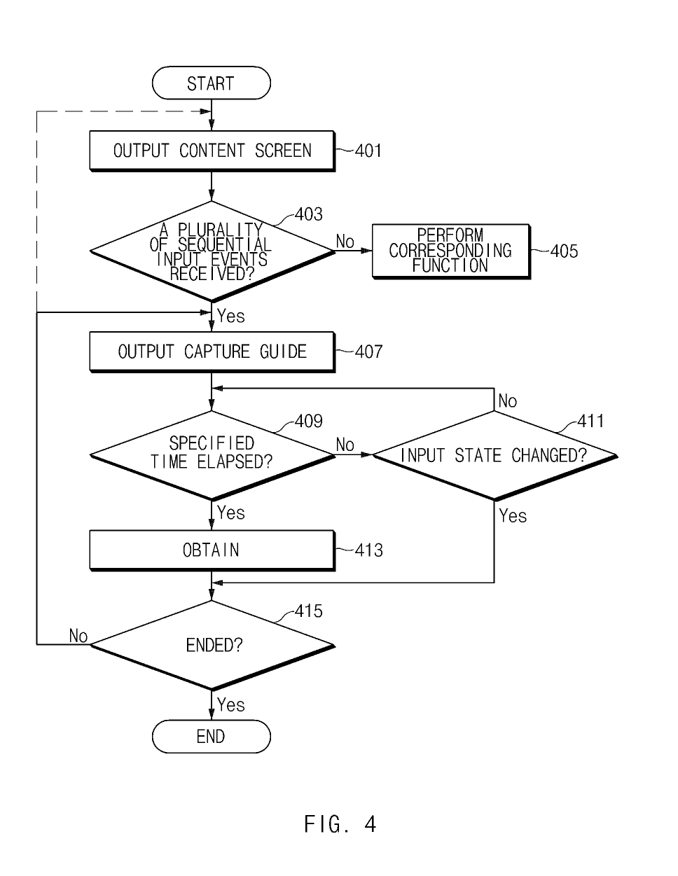

FIG. 4 is a flowchart illustrating a content obtaining method, according to another embodiment of the present disclosure.

Referring to FIG. 4, in operation 401, the processor 200 (or the processor 120) outputs a content screen to the display 160. For example, if an event of requesting playback of specified content, an event of executing a specified application, or an event of requesting access to the server 106 occurs, the processor 200 may output the content screen corresponding to the event.

In operation 403, the processor 200 determines whether a plurality of sequential input events are received. For example, the processor 200 may determine whether a plurality of input events (e.g., tap events of touching certain points on the display) which occur within a specified time or at an interval less than a specified time are received. If input events of which an occurrence time exceeds a specified time or of which an interval exceeds a specified time are received, the processor 200 executes a function according to the type of a previously obtained input event in operation 405. For example, the processor 200 may modify content or may output other content to the display 160 in response to an obtained input event.

If a plurality of sequential input events are received, the processor 200 outputs a capture guide in operation 407. For example, the processor 200 may output, to the display 160, the capture guide including location values of the input events. Alternatively, the processor 200 may output the capture guide which forms a certain closed surface by connecting only adjacent location values of the input events. A line that connects the adjacent location values of the input events may include at least one of a straight line or a free curve.

According to various embodiments of the present disclosure, the processor 200 may output different capture guides according to a content type. For example, in the case where the content is a text, the processor 200 may output the capture guide including regions on which text is displayed. In this operation, the processor 200 may differently handle selected text regions according to the number of the input events. For example, the processor 200 may determine a location of an initial input event among the input events as a start point of a text region to be obtained. Furthermore, the processor 200 may determine a location of a last input event among the input events as an end point of the text region to be obtained. The processor 200 may select a text region for each location of input events input between the initial input event and the last input event or may not select a certain text region. Based on this configuration, the processor 200 may obtain a plurality of partial text regions among all text regions at one time by the input events.

In operation 409, the processor 200 determines whether a specified time has elapsed since the output of the capture guide. If the specified time has not elapsed, the processor 200 determines whether an input state is changed, at a certain period or in real time in operation 411. If the input state is not changed, the process returns to operation 409 so that the processor 200 may repeat operation 409 and the subsequent operations. If the input state is changed, operation 413 may be skipped, and the process proceeds to operation 415. Alternatively, according to various embodiments of the present disclosure, the processor 200 may re-output the capture guide according to a change of the input state, and may determine whether the specified time has elapsed. For example, in the case where a location of at least one of the input events is changed, or a new input event is added, or at least one of the input events is removed, the processor 200 may output the capture guide adjusted according to the aforementioned case.

If the specified time has elapsed since the output of the capture guide, the processor 200 handles (obtains) acquisition of a part of content in operation 413. The processor 200 determines whether an event related to termination of a content obtaining function occurs in operation 415. If the event related to termination of the content obtaining function does not occur, the process returns to operation 407 so that the processor 200 may repeat operation 407 and the subsequent operations. For example, if the input state is changed before elapse of a specified time, the process may return to operation 407 so that the processor 200 may output the capture guide according to the change of the input state. Alternatively, the process may return to operation 401 so that the processor 200 may maintain a content screen output state.

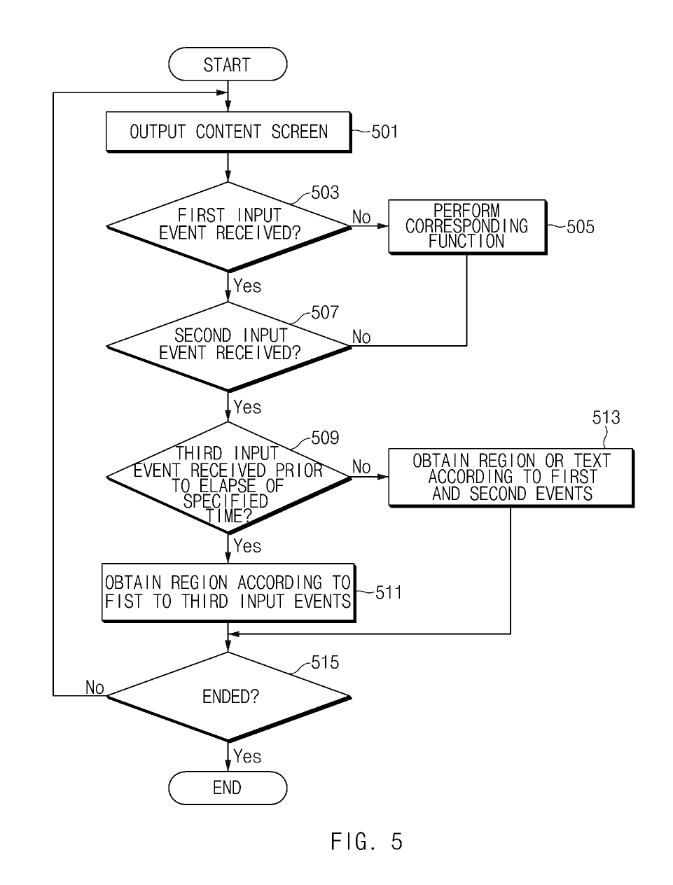

FIG. 5 is a flowchart illustrating a content obtaining method, according to another embodiment of the present disclosure.

Referring to FIG. 5, in operation 501, the processor 200 (or the processor 120) of the electronic device 100 outputs, to the display 160, a content screen in response to a specified event or a preset schedule.

In operation 503, the processor 200 determines whether an input event that has occurred is a first input event. If the first input event is not received, the processor 200 performs execution of a corresponding function in operation 505. For example, according to the type of the input event that has occurred, the processor 200 may perform a content search function for outputting another content screen or a scroll function. Alternatively, if no input event occurs, the processor 200 may enter a sleep screen state or may maintain a screen state of operation 501.

If the first input event (e.g., an event of touching and holding a specific portion of the display 160 while the content screen is output) is received, the processor 200 determines whether a second input event is received within a specified time in operation 507. If the second input event is not received within a specified time, the processor 200 performs execution of a function corresponding to the first input event in operation 505. For example, the processor 200 may select an entire content screen in response to the first input event, and may move the content screen in response to a modification (e.g., a drag event) of the first input event.

If the second input event is received, the processor 200 determines whether a third input event is received prior to elapse of a specified time in operation 509. If the third input event occurs prior to the elapse of the specified time, the processor 200 performs capturing (or obtaining) a region according to the first to third input events in operation 511. In relation to this operation, the processor 200 may obtain a location value of the first input event, a location value of the second input event, and a location value of the third input event, and may draw virtual lines connecting the location values, and then may obtain a content region based on a closed surface formed by the virtual lines. If the content region is obtained, the processor 200 may store the content region in the memory 130 automatically or in response to a user input. Alternatively, the processor 200 may output, to the display 160, a popup window or a new window including the content region alone. Alternatively, the processor 200 may transmit the content region to the external electronic device 104 automatically or in response to a user input.

If the third input event is not received prior to the elapse of the specified time, the processor 200 obtains a region or a text according to the first input event or the second input event in operation 513. In relation to this operation, the processor 200 may determine a virtual capture space including the first input event and the second input event. For example, the processor 200 may provide, as a capture guide, a closed curve (e.g., a quadrangle, a circle, an ellipse, and the like) including the location value of the first input event and the location value of the second input event. If a specified time has elapsed, the processor 200 may obtain a content region based on the closed curve.

According to various embodiments of the present disclosure, the processor 200 may determine the type of content displayed on the locations of the first input event and the second input event which have occurred on the content screen. In the case where only a text is included within a capture guide region determined by the first input event and the second input event, the processor 200 may obtain a text included within the closed curve. In the case where only an image is included within the capture guide region determined by the first input event and the second input event, the processor 200 may obtain an image based on the closed curve. In the case where an image and a text are included within the capture guide region determined by the first input event and the second input event, the processor 200 may obtain a text as an image. Accordingly, the processor 200 may obtain pieces of content included within the closed curve as an image.

According to various embodiments of the present disclosure, the second input event may include an event (e.g., a drag event) which is changed or moved. If the second input event which is moved occurs after the occurrence of the first input event, the processor 200 may perform acquisition of a content part of a region including the location value of the first input event and a movement trajectory of the second input event. For example, the processor 200 may obtain a content part of a region connecting a first location value at which the first input event occurs and a start location value, a movement trajectory value, and a movement end location value of the second input event.

The processor 200 determines whether an event related to termination of a content obtaining function occurs in operation 515. If the event related to termination of the content obtaining function occurs, the processor 200 may stop playback of content or may deactivate the capture application 131. If the event related to termination of the content obtaining function does not occur, the process may return to operation 501 so that the processor 200 may repeat operation 501 and the following operations.

According to various embodiments of the present disclosure, a content region obtaining method may include displaying content, receiving input events sequentially input to a display, on which the content is displayed, within a specified time or at an interval of less than a specified time, and selecting a partial region of the content based on the received input events and obtaining and displaying the selected partial region of the content according to a specified condition.

According to various embodiments of the present disclosure, the method may further include outputting a capture guide including at least a portion of input locations of the received input event.

According to various embodiments of the present disclosure, the outputting the capture guide may include outputting the capture guide including the input locations of the received input events and a straight line or a curved line connecting adjacent input locations among the input location values.

According to various embodiments of the present disclosure, the method may further include receiving an additional input event related to a location change of at least one of the input events and adjusting a shape of the capture guide in response to the additional input event to output the capture guide.

According to various embodiments of the present disclosure, the method may further include outputting, as a first capture guide, a figure including a location value of a first input event and a location value of a second input event input within a specified time as diagonally opposite corners.

According to various embodiments of the present disclosure, the method may further include outputting, if a third input event is received while the first capture guide is output, a second capture guide obtained by modifying the first capture guide in relation to an input location value of the third input event.

According to various embodiments of the present disclosure, the method may further include outputting, as the second capture guide, a figure including the location value of the first input event, the location value of the second input event input within a specified time, and the location value of the third input events as corner values.

According to various embodiments of the present disclosure, the displaying may include outputting the obtained partial region of the content to a popup window or a new window.

According to various embodiments of the present disclosure, the displaying may include outputting the obtained partial region of the content in a full screen.

According to various embodiments of the present disclosure, the method may further include determining the type of the content and differently outputting the capture guide corresponding to the received input events according to the type of the content.

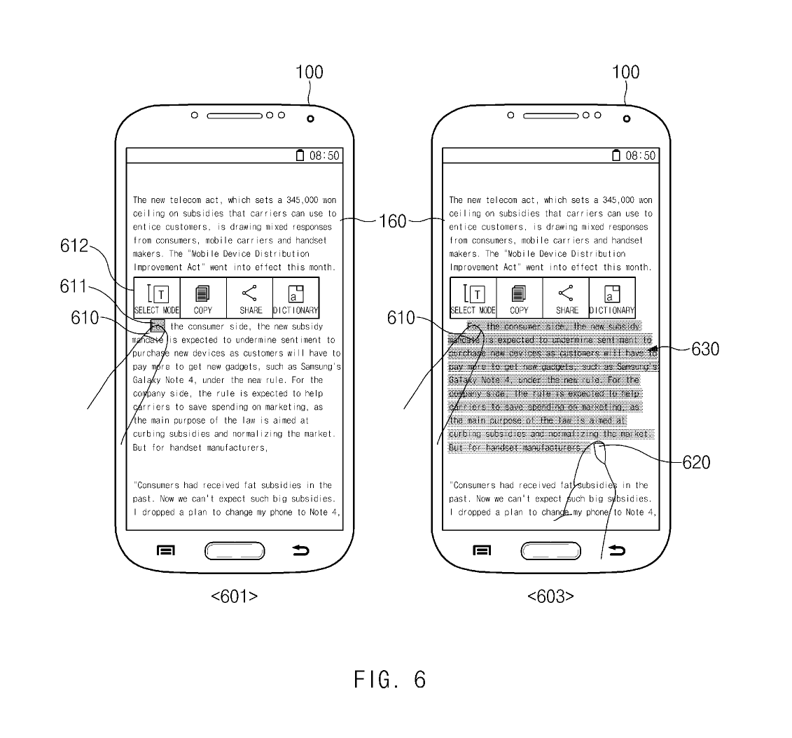

FIG. 6 is a diagram illustrating a screen interface related to a content obtaining function, according to an embodiment of the present disclosure.

Referring to FIG. 6, as shown in state 601, the electronic device 100 may output text content to the display 160. For example, the electronic device 100 may output a text screen to the display 160 when an icon or a menu corresponding to text content (e.g., a document or e-book) is selected. Alternatively, the electronic device 100 may output, to the display 160, a text-containing web page when a web page related to a text is received.

If an input event 610 occurs while the text is output, the electronic device 100 may check location information of the input event 610. The electronic device 100 may output a specified capture guide 611 (e.g., color inversion) to an occurrence point of the input event 610 or a region adjacent to the occurrence point. Furthermore, the electronic device 100 may output a specified functional window 612 in response to occurrence of the input event 610.

According to various embodiments of the present disclosure, a second input event may occur under a specified condition (e.g., at least one of a touchdown by the input event 610 should not be released or that a current time is prior to elapse of a specified time) after the input event 610 is input. An input event 620, for example, may correspond to an input event of touching another region of a text screen as shown in state 603. In the case where the input event 610 and the input event 620 occur within a specified time, the electronic device 100 may determine a certain area 630 based on the input event 610 and the input event 620. The certain area 630, for example, may include an area indicating texts contained within a certain shape (e.g., a quadrangle) including an occurrence point of the input event 610 and an occurrence point of the input event 620.

According to various embodiments of the present disclosure, the electronic device 100 may obtain the text within the certain area 630 automatically or in response to a user input. For example, if a specified time has elapsed since the occurrence of the input event 610 and the input event 620, the electronic device 100 may automatically obtain the text within the certain area 630. Alternatively, if the input event 610 and the input event 620 are modified so that a specified gesture event (e.g., pinch zoom-in event) occurs, the electronic device 100 may automatically obtain the text within the certain area 630.

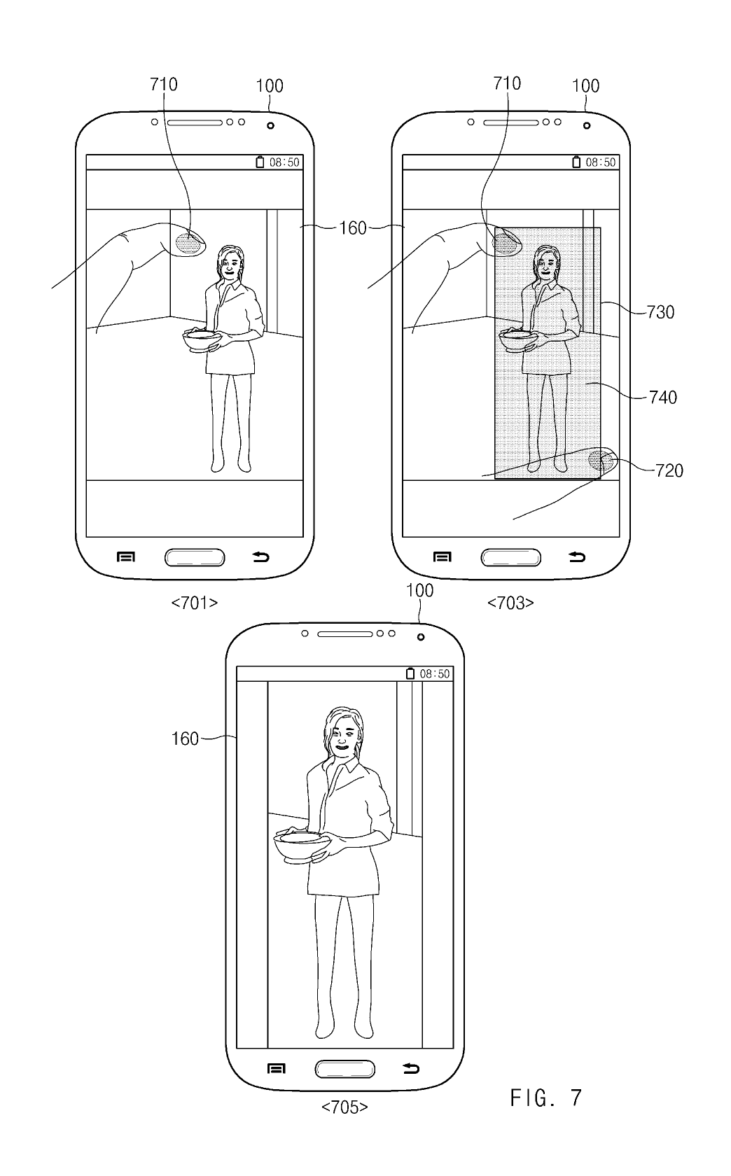

FIG. 7 is a diagram illustrating a screen interface related to a content obtaining function, according to another embodiment of the present disclosure.

Referring to FIG. 7, as shown in state 701, the electronic device 100 may output image content to the display 160 in response to selection of content or execution of a specified application. The image content may include, for example, a picture, a web page etc.

After an input event 710 occurs as shown in state 701, the electronic device 100 may receive an input event 720 under a specified condition as shown in state 703. In this case, the electronic device 100 may output, to the display 160, a capture guide 730 including a location value of the input event 710 and a location value of the input event 720. The capture guide 730, for example, may have a different color from that of a periphery of the capture guide 730. According to an embodiment of the present disclosure, the electronic device 100 may output, as the capture guide 730, a rectangle having the location value of the input event 710 and the location value of the input event 720 as diagonally opposite corners.

As the capture guide 730 is output and a specified condition (e.g., elapse of a specified time or occurrence of a user input) is satisfied, a content part region 740 may be obtained. In relation to the content part region 740 obtained, the electronic device 100 may output the content part region 740 to the display 160 in a full screen as shown in state 705. In this operation, the electronic device 100 may maintain an image aspect ratio corresponding to the capture guide 730. In relation to maintaining the image aspect ratio of the capture guide 730, the electronic device 100 may treat certain regions on the display 160 as a margin. According to various embodiments of the present disclosure, if a back key or a cancel key is pressed or an input event for returning to a previous screen occurs, the electronic device 100 may restore the screen to which the image content is output as shown in state 701.

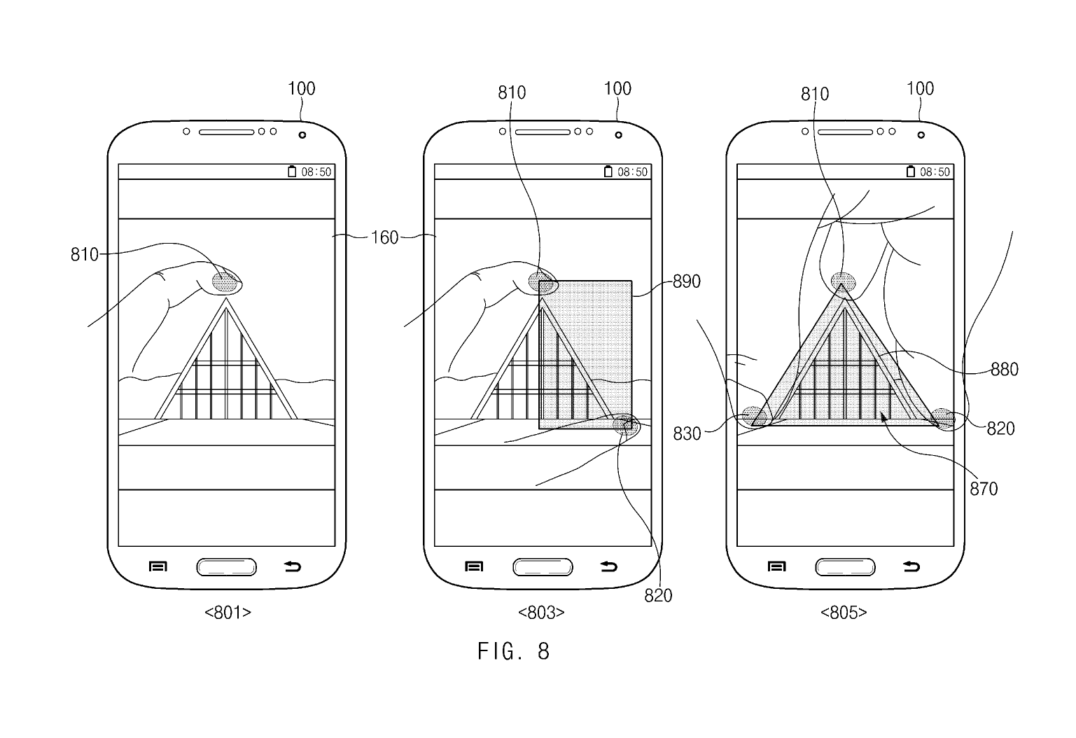

FIG. 8 is a diagram illustrating a screen interface related to a content obtaining function, according to another embodiment of the present disclosure.

Referring to FIG. 8, as shown in state 801, the electronic device 100 may output a content screen to the display 160 in response to a content display request. If an input event 810 occurs while content is displayed, the electronic device 100 may receive location information of the input event 810.

The electronic device 100 may receive an input event 820 under a specified condition (e.g., prior to elapse of a specified time or prior to release of the input event 810) as shown in state 803. The electronic device 100 may output a first capture guide 890 including a first location value (e.g., a location value on a touch screen) of the input event 810 and a second location value of the input event 820. For example, the electronic device 100 may output, to the display 160, the first capture guide 160 shaped like a rectangle and having the first location value and the second location value as diagonally opposite corners.

According to various embodiments of the present disclosure, the electronic device 100 may receive an input event 830 under a specified condition as shown in state 805. In this case, the electronic device 100 may receive a third location value of the input event 830. The electronic device 100 may output a second capture guide 870 including the first to third location values as shown in state 805. For example, the electronic device 100 may output, to the display 160, the second capture guide 870 shaped like a triangle and having the first to third location values as corners. The first capture guide 890 and the second capture guide 870, for example, may have different colors (e.g., inverted colors or specified colors) from the colors of peripheries of the first capture guide 890 and the second capture guide 870.

If a specified condition (e.g., elapse of a specified time) is satisfied, the electronic device 100 may obtain a content part region 880 within a certain area specified by the second capture guide 870. The electronic device 100 may add the content part region 880 to a new window to output the content part region 880 to the display 160 or may output the content part region 880 through a popup window.

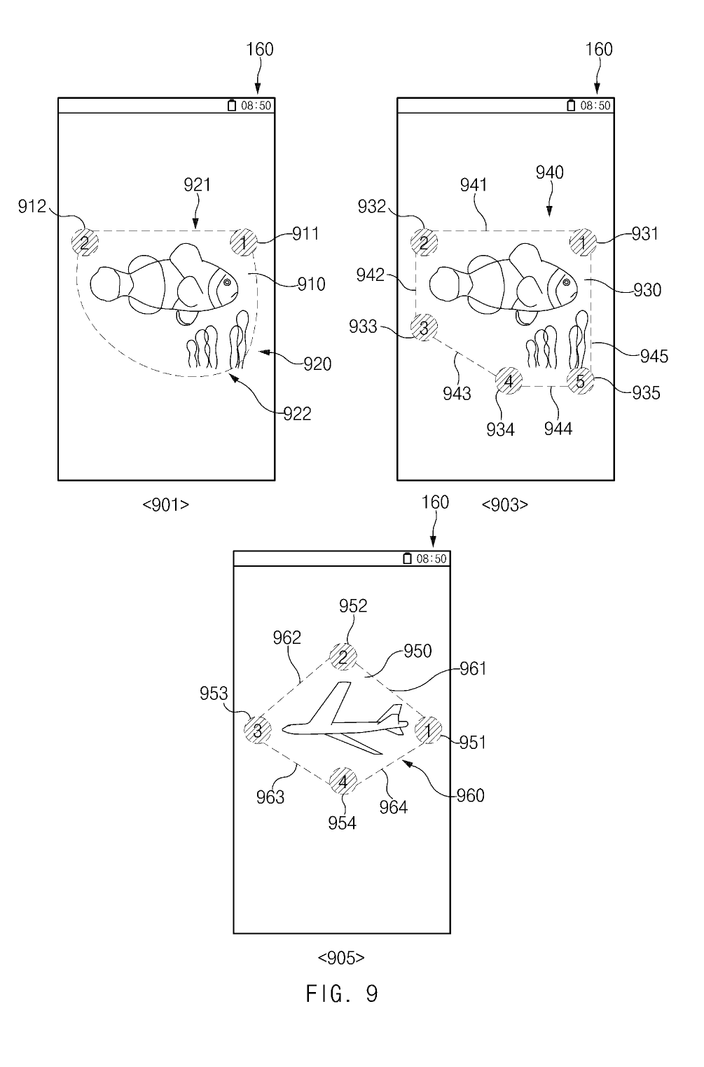

FIG. 9 is a diagram illustrating a screen interface related to a content obtaining function, according to an embodiment of the present disclosure.

Referring to FIG. 9, as shown in state 901, the electronic device 100 may output a specified content screen to the display 160 in response to a content output request. While the content screen is output, the electronic device 100 may receive at least one input event. For example, the electronic device 100 may receive a first touch event of touching a point 911 and a second touch event of touching a point 912 within a specified time. Furthermore, the electronic device 100 may receive a drag event corresponding to a free curve 922 connecting the point 911 and the point 912 in response to a user input. In this case, the electronic device 100 may arbitrarily or automatically generate a straight line 921 connecting the point 911 and the point 912. The electronic device 100 may provide, as a first capture guide 920, a closed surface including the point 911, the straight line 921, the point 912, and the free curve 922. If a specified time has elapsed, the electronic device 100 may obtain a first content part region 910 corresponding to the first capture guide 920.

According to various embodiments of the present disclosure, as shown in state 903, the electronic device 100 may output a specified content screen to the display 160 in response to a content output request. For example, the electronic device 100 may receive a first touch event of touching a point 931, a second touch event of touching a point 932, a third touch event of touching a point 933, a fourth touch event of touching a point 934, and a fifth touch event of touching a point 935 under a specified condition. In this case, the electronic device 100 may arbitrarily or automatically generate a straight line 941 connecting the point 931 and the point 932, a straight line 942 connecting the point 932 and the point 933, a straight line 943 connecting the point 933 and the point 934, a straight line 944 connecting the point 934 and the point 935, and a straight line 945 connecting the point 935 and the point 931. The electronic device 100 may provide, as a second capture guide 940, a closed surface including the point 931, the straight line 941, the point 932, the straight line 942, the point 933, the straight line 943, the point 934, the straight line 944, the point 935, and the straight line 945. If a specified time has elapsed, the electronic device 100 may obtain a second content part region 930 corresponding to the second capture guide 940. The above-mentioned touch events, for example, may include touch events (e.g., tap events) or touchdown events (or hold events) sequentially input at an interval of less than a specified time.

According to various embodiments of the present disclosure, as shown in state 905, the electronic device 100 may output a specified content screen to the display 160 in response to a content output request. For example, the electronic device 100 may receive a first touch event of touching a point 951, a second touch event of touching a point 952, a third touch event of touching a point 953, and a fourth touch event of touching a point 954 under a specified condition. In this case, the electronic device 100 may arbitrarily or automatically generate a straight line 961 connecting the point 951 and the point 952, a straight line 962 connecting the point 952 and the point 953, a straight line 963 connecting the point 953 and the point 954, and a straight line 964 connecting the point 954 and the point 951. The electronic device 100 may provide, as a third capture guide 960, a closed surface including the point 951, the straight line 961, the point 952, the straight line 962, the point 953, the straight line 963, the point 954, and the straight line 964. If a specified time has elapsed, the electronic device 100 may obtain a third content part region 950 corresponding to the third capture guide 960. The above-mentioned touch events, for example, may include touch events (e.g., tap events) or touchdown events (or hold events) sequentially input at an interval of less than a specified time.

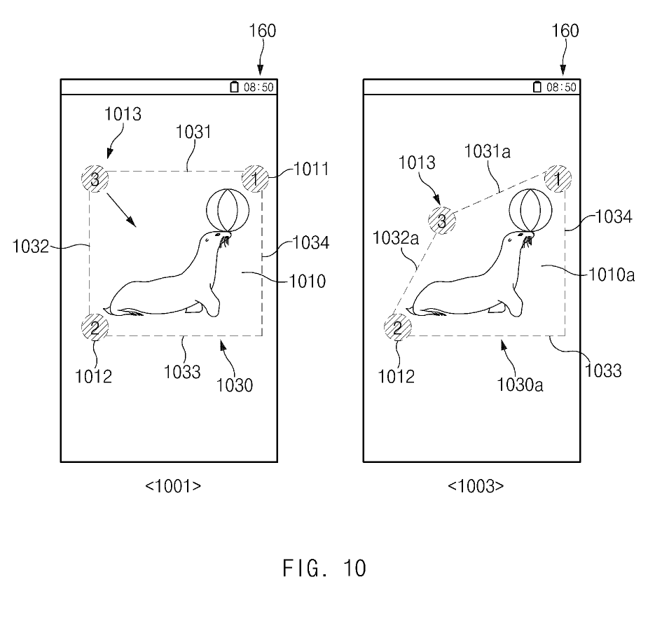

FIG. 10 is a diagram illustrating a screen interface related to a content obtaining function, according to another embodiment of the present disclosure.

Referring to FIG. 10, as shown in state 1001, the electronic device 100 may output specific content (e.g., an image) to the display 160 in response to a content output request. If an input event occurs while the content is output, the electronic device 100 may receive a location value of the input event. According to an embodiment of the present disclosure, the electronic device 100 may receive location values of a plurality of input events sequentially input under a specified condition (e.g., within a specified time). For example, the electronic device 100 may receive a first input event occurring on a point 1011, a second input event occurring on a point 1012, and a third input event occurring on a point 1013. In this case, the electronic device 100 may generate a straight line 1031 connecting the point 1011 and the point 1013, a straight line 1032 connecting the point 1013 and the point 1012, and a bent line 1033-1034 connecting the point 1011 and the point 1012. The electronic device 100 may output, as a capture guide 1030, a certain shape (e.g., a quadrangle) including the point 1011, the straight line 1031, the point 1013, the straight line 1032, the point 1012, and the bent line 1033-1034. If a specified condition is satisfied, the electronic device 100 may obtain a content part region 1010 within a region determined by the capture guide 1030.

According to various embodiments of the present disclosure, the third touch event occurring on the point 1013 may be modified (or moved) before a specified condition is satisfied (e.g., prior to elapse of a specified time or prior to release of the first to third touch events). For example, the point 1013 may be dragged and moved by a certain distance in a lower right diagonal direction. In this case, the electronic device 100 may newly generate a straight line 1031a connecting the point 1011 and the point 1013 and a straight line 1032a connecting the point 1013 and the point 1012. Accordingly, the electronic device 100 may output, to the display 160, a capture guide 1030a including the point 1011, the straight line 1031a, the point 1013, the straight line 1032a, the point 1012, and the bent line 1033-1034. The electronic device 100 may obtain a content part region 1031a specified by the capture guide 1030a according to a specified condition (e.g., elapse of a certain time or occurrence of an acquisition request event).

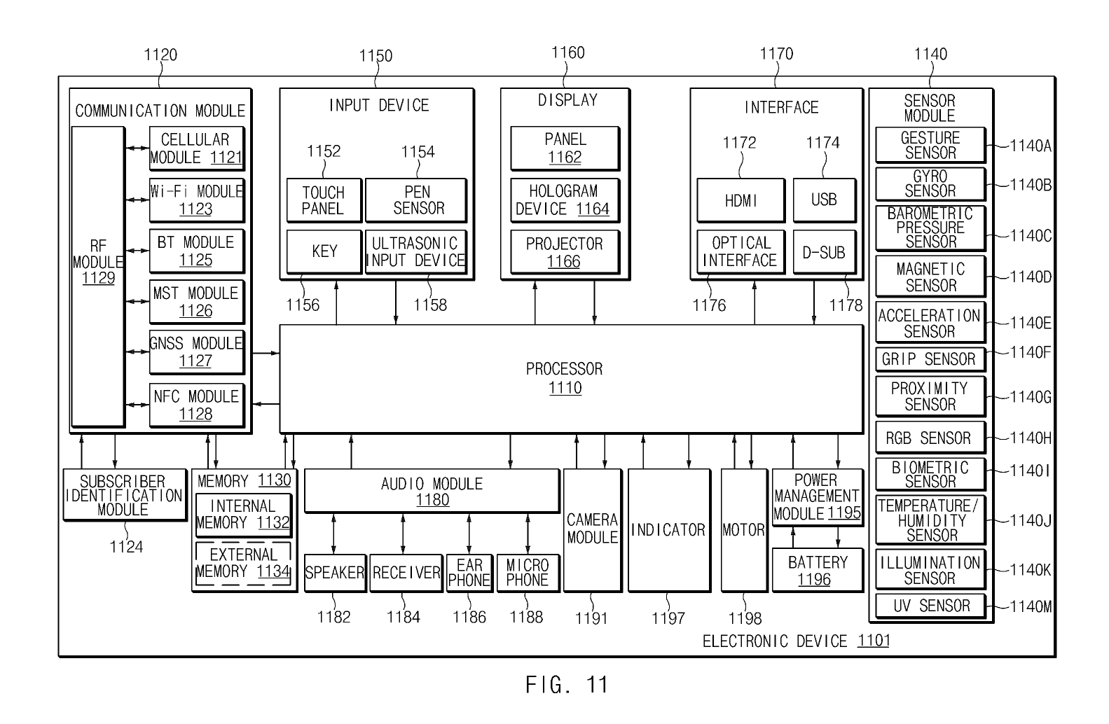

FIG. 11 is a block diagram illustrating an electronic device according to an embodiment of the present disclosure.

An electronic device 1101 may include, for example, a part or the entirety of the electronic device 100 of FIG. 1. The electronic device 1101 includes at least one processor (e.g., an application processor (AP)) 1110, a communication module 1120, a subscriber identification module 1124, a memory 1130, a sensor module 1140, an input device 1150, a display 1160, an interface 1170, an audio module 1180, a camera module 1191, a power management module 1195, a battery 1196, an indicator 1197, and a motor 1198.

The processor 1110 may run an operating system or an application program so as to control a plurality of hardware or software elements connected to the processor 1110, and may process various data and perform operations. The processor 1110 may be implemented with, for example, a system on chip (SoC). According to an embodiment of the present disclosure, the processor 1110 may further include a graphic processing unit (GPU) and/or an image signal processor. The processor 1110 may load, on a volatile memory, an instruction or data received from at least one of other elements (e.g., a nonvolatile memory) to process the instruction or data, and may store various data in a nonvolatile memory.

The communication module 1120 includes, for example, a cellular module 1121, a Wi-Fi module 1123, a Bluetooth module 1125, a GNSS module 1127 (e.g., a GPS module, a GLONASS module, a Beidou module, or a Galileo module), an NFC module 1128, a magnetic stripe transmission (MST) module 1126, and a radio frequency (RF) module 1129.

The cellular module 1121 may provide, for example, a voice call service, a video call service, a text message service, or an Internet access service through a communication network. According to an embodiment of the present disclosure, the cellular module 1121 may identify and authenticate the electronic device 1101 in the communication network using the subscriber identification module 1124 (e.g., a SIM card). The cellular module 1121 may perform at least a part of functions provided by the processor 1110. The cellular module 1121 may include a communication processor (CP).

Each of the Wi-Fi module 1123, the Bluetooth module 1125, the GNSS module 1127, the NFC module 1128, and the MST module may include, for example, a processor for processing data transmitted/received through the modules. According to various embodiments of the present disclosure, at least two of the cellular module 1121, the Wi-Fi module 1123, the Bluetooth module 1125, the GNSS module 1127, the NFC module 1128, and the MST module may be included in a single integrated chip (IC) or IC package.

The RF module 1129 may transmit/receive, for example, communication signals (e.g., RF signals). The RF module 1129 may include, for example, a transceiver, a power amp module (PAM), a frequency filter, a low noise amplifier (LNA), an antenna, and the like. According to another embodiment of the present disclosure, at least one of the cellular module 1121, the Wi-Fi module 1123, the Bluetooth module 1125, the GNSS module 1127, the NFC module 1128, or the MST module may transmit/receive RF signals through a separate RF module.

The subscriber identification module 1124 may be a SIM card and include, for example, an embedded SIM containing a subscriber identification module, and may include unique identification information (e.g., an integrated circuit card identifier (ICCID)) or subscriber information (e.g., international mobile subscriber identity (IMSI)).

The memory 1130 includes an internal memory 1132 or an external memory 1134. The internal memory 1132 may include at least one of a volatile memory (e.g., a dynamic RAM (DRAM), a static RAM (SRAM), a synchronous dynamic RAM (SDRAM), and the like) or a nonvolatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, a NOR flash memory, and the like), a hard drive, or a solid state drive (SSD)).

The external memory 1134 may include a flash drive, for example, compact flash (CF), secure digital (SD), micro secure digital (Micro-SD), mini secure digital (Mini-SD), extreme digital (xD), multi-media card (MMC), a memory stick, and the like. The external memory 1134 may be operatively and/or physically connected to the electronic device 1101 through various interfaces.

The sensor module 1140 may, for example, measure physical quantity or detect an operation state of the electronic device 1101 so as to convert measured or detected information into an electrical signal. The sensor module 1140 may include, for example, at least one of a gesture sensor 1140A, a gyro sensor 1140B, a barometric pressure sensor 1140C, a magnetic sensor 1140D, an acceleration sensor 1140E, a grip sensor 1140F, a proximity sensor 1140G, a color sensor 1140H (e.g., a red/green/blue (RGB) sensor), a biometric sensor 1140I, a temperature/humidity sensor 1140J, an illumination sensor 1140K, or an ultraviolet (UV) sensor 1140M. Additionally or alternatively, the sensor module 1140 may include, for example, an olfactory sensor (E-nose sensor), an electromyography (EMG) sensor, an electroencephalogram (EEG) sensor, an electrocardiogram (ECG) sensor, an infrared (IR) sensor, an iris sensor, and/or a fingerprint sensor. The sensor module 1140 may further include a control circuit for controlling at least one sensor included therein. In various embodiments of the present disclosure, the electronic device 1101 may further include a processor configured to control the sensor module 1140 as a part of the processor 1110 or separately, so that the sensor module 1140 is controlled while the processor 1110 is in a sleep state.

The input device 1150 includes, for example, a touch panel 1152, a (digital) pen sensor 1154, a key 1156, or an ultrasonic input device 1158. The touch panel 1152 may employ at least one of capacitive, resistive, infrared, and ultraviolet sensing methods. The touch panel 1152 may further include a control circuit. The touch panel 1152 may further include a tactile layer so as to provide a haptic feedback to a user.

The (digital) pen sensor 1154 may include, for example, a sheet for recognition which is a part of a touch panel or is separate. The key 1156 may include, for example, a physical button, an optical button, or a keypad. The ultrasonic input device 1158 may sense ultrasonic waves generated by an input tool through a microphone 1188 so as to identify data corresponding to the ultrasonic waves sensed.

The display 1160 (e.g., the display 160) includes a panel 1162, a hologram device 1164, or a projector 1166. The panel 1162 may be, for example, flexible, transparent, or wearable. The panel 1162 and the touch panel 1152 may be integrated into a single module. The hologram device 1164 may display a stereoscopic image in a space using a light interference phenomenon. The projector 1166 may project light onto a screen so as to display an image. The screen may be disposed in the inside or the outside of the electronic device 1101. According to an embodiment of the present disclosure, the display 1160 may further include a control circuit for controlling the panel 1162, the hologram device 1164, or the projector 1166.

The interface 1170 includes, for example, a high-definition multimedia interface (HDMI) 1172, a universal serial bus (USB) 1174, an optical interface 1176, or a D-subminiature (D-sub) 1178. Additionally or alternatively, the interface 1170 may include, for example, a mobile high-definition link (MHL) interface, a secure digital (SD) card/multi-media card (MMC) interface, or an infrared data association (IrDA) interface.

The audio module 1180 may convert, for example, a sound into an electrical signal or vice versa. The audio module 1180 may process sound information input or output through a speaker 1182, a receiver 1184, an earphone 1186, or the microphone 1188.

According to an embodiment of the present disclosure, the camera module 1191 for capturing a still image or a video may include, for example, at least one image sensor (e.g., a front sensor or a rear sensor), a lens, an image signal processor (ISP), or a flash (e.g., an LED or a xenon lamp).

The power management module 1195 may manage power of the electronic device 1101. According to an embodiment of the present disclosure, the power management module 1195 may include a power management integrated circuit (PMIC), a charger integrated circuit (IC), or a battery gauge. The PMIC may employ a wired and/or wireless charging method. The wireless charging method may include, for example, a magnetic resonance method, a magnetic induction method, an electromagnetic method, and the like. An additional circuit for wireless charging, such as a coil loop, a resonant circuit, a rectifier, and the like, may be further included. The battery gauge may measure, for example, a remaining capacity of the battery 1196 and a voltage, current or temperature thereof while the battery is charged. The battery 1196 may include, for example, a rechargeable battery and/or a solar battery.

The indicator 1197 may display a specific state of the electronic device 1101 or a part thereof (e.g., the processor 1110), such as a booting state, a message state, a charging state, and the like. The motor 1198 may convert an electrical signal into a mechanical vibration, and may generate a vibration or haptic effect. A processing device (e.g., a GPU) for supporting a mobile TV may be included in the electronic device 1101. The processing device for supporting a mobile TV may process media data according to the standards of digital multimedia broadcasting (DMB), digital video broadcasting (DVB), MediaFLO™, and the like.

Each of the elements described herein may be configured with one or more components, and the names of the elements may be changed according to the type of electronic device. In various embodiments of the present disclosure, an electronic device may include at least one of the elements described herein, and some elements may be omitted or other additional elements may be added. Furthermore, some of the elements of the electronic device may be combined with each other so as to form one entity, so that the functions of the elements may be performed in the same manner as before the combination.

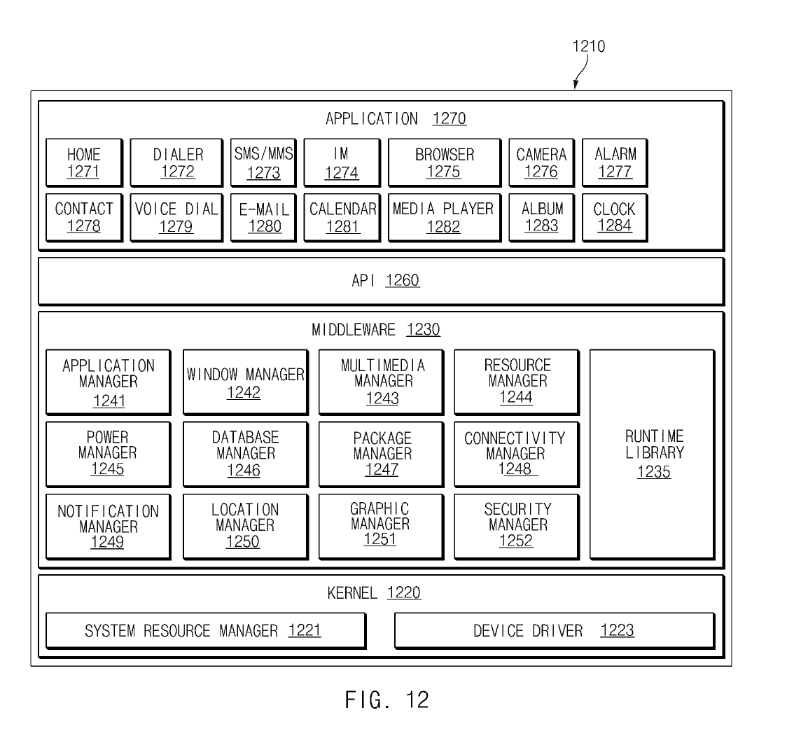

FIG. 12 is a block diagram illustrating a program module, according to various embodiments of the present disclosure.

According to an embodiment of the present disclosure, a program module 1210 may include an operating system (OS) for controlling a resource related to an electronic device and/or various applications running on the OS. The operating system may be, for example, Android, iOS, Windows, Symbian, Tizen, Bada, and the like.

The program module 1210 includes a kernel 1220, a middleware 1230, an application programming interface (API) 1260, and/or an application 1270. At least a part of the program module 1210 may be preloaded on the electronic device or may be downloaded from an external electronic device.

The kernel 1220 includes, for example, a system resource manager 1221 and/or a device driver 1223. The system resource manager 1221 may perform control, allocation, or retrieval of a system resource. According to an embodiment of the present disclosure, the system resource manager 1221 may include a process management unit, a memory management unit, a file system management unit, and the like. The device driver 1223 may include, for example, a display driver, a camera driver, a Bluetooth driver, a shared memory driver, a USB driver, a keypad driver, a Wi-Fi driver, an audio driver, or an inter-process communication (IPC) driver.

The middleware 1230, for example, may provide a function that the applications 1270 require in common, or may provide various functions to the applications 1270 through the API 1260 so that the applications 1270 may efficiently use limited system resources in the electronic device. According to an embodiment of the present disclosure, the middleware 1230 includes at least one of a runtime library 1235, an application manager 1241, a window manager 1242, a multimedia manager 1243, a resource manager 1244, a power manager 1245, a database manager 1246, a package manager 1247, a connectivity manager 1248, a notification manager 1249, a location manager 1250, a graphic manager 1251, or a security manager 1252.

The runtime library 1235 may include, for example, a library module that a complier uses to add a new function through a programming language while the application 1270 is running. The runtime library 1235 may perform a function for input/output management, memory management, or an arithmetic function.

The application manager 1241 may mange, for example, a life cycle of at least one of the applications 1270. The window manager 1242 may manage a GUI resource used in a screen. The multimedia manager 1243 may recognize a format required for playing various media files and may encode or decode a media file using a codec matched to the format. The resource manager 1244 may manage a resource such as a source code, a memory, or a storage space of at least one of the applications 1270.

The power manager 1245, for example, may operate together with a basic input/output system (BIOS) to manage a battery or power and may provide power information required for operating the electronic device. The database manager 1246 may generate, search, or modify a database to be used in at least one of the applications 1270. The package manager 1247 may manage installation or update of an application distributed in a package file format.

The connectivity manger 1248 may manage wireless connection of Wi-Fi, Bluetooth, and the like. The notification manager 1249 may display or notify an event such as message arrival, appointments, and proximity alerts in such a manner as not to disturb a user. The location manager 1250 may manage location information of the electronic device. The graphic manager 1251 may manage a graphic effect to be provided to a user or a user interface related thereto. The security manager 1252 may provide various security functions required for system security or user authentication. According to an embodiment of the present disclosure, in the case in which an electronic device includes a phone function, the middleware 1230 may further include a telephony manager for managing a voice or video call function of the electronic device.

The middleware 1230 may include a middleware module for forming a combination of various functions of the above-mentioned elements. The middleware 1230 may provide a module specialized for each type of an operating system to provide differentiated functions. Furthermore, the middleware 1230 may delete a part of existing elements or may add new elements dynamically.

The API 1260 which is, for example, a set of API programming functions may be provided in different configurations according to an operating system. For example, in the case of Android or iOS, one API set may be provided for each platform, and, in the case of Tizen, at least two API sets may be provided for each platform.

The application 1270, for example, includes at least one application for providing functions such as a home 1271, a dialer 1272, an SMS/MMS 1273, an instant message (IM) 1274, a browser 1275, a camera 1276, an alarm 1277, a contact 1278, a voice dial 1279, an e-mail 1280, a calendar 1281, a media player 1282, an album 1283, a clock 1284, health care (e.g., measure an exercise amount or blood sugar level), or environmental information provision (e.g., provide air pressure, humidity, or temperature information).

According to an embodiment of the present disclosure, the application 1270 may include an information exchange application for supporting information exchange between the electronic device 100 or 1101 and an external electronic device. The information exchange application may include, for example, a notification relay application for relaying specific information to the external electronic device or a device management application for managing the external electronic device.

For example, the notification relay application may have a function for relaying, to an external electronic device, notification information generated in another application (e.g., an SMS/MMS application, an e-mail application, a health care application, an environmental information application, and the like) of the electronic device. Furthermore, the notification relay application may receive notification information from the external electronic device and may provide the received notification information to the user.

The device management application, for example, may manage (e.g., install, delete, or update) at least one function (e.g., turn-on/turn off of an external electronic device itself (or some elements) or the brightness (or resolution) adjustment of a display) of the external electronic device communicating with the electronic device, an application running in the external electronic device, or a service (e.g., a call service or a message service) provided from the external electronic device.

According to an embodiment of the present disclosure, the application 1270 may include a specified application (e.g., a healthcare application of a mobile medical device) according to an attribute of the external electronic device. The application 1270 may include an application received from the external electronic device. The application 1270 may include a preloaded application or a third-party application downloadable from a server. The names of the elements of the program module 1210 illustrated may vary with the type of an operating system.

According to various embodiments of the present disclosure, at least a part of the program module 1210 may be implemented with software, firmware, hardware, or a combination thereof. At least a part of the program module 1210, for example, may be implemented (e.g., executed) by a processor (e.g., the processor 120, the processor 200, or the processor 1110). At least a part of the program module 1210 may include, for example, a module, a program, a routine, sets of instructions, or a process for performing at least one function.

The term “module” as used herein may represent, for example, a unit including one of hardware, software and firmware or a combination thereof. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific integrated circuit (ASIC) chip, a field-programmable gate array (FPGA), and a programmable-logic device for performing some operations, which are known or will be developed.

At least a part of devices (e.g., modules or functions thereof) or methods (e.g., operations) according to various embodiments of the present disclosure may be implemented as instructions stored in a non-transitory computer-readable storage medium in the form of a program module. In the case where the instructions are performed by a processor, the processor may perform functions corresponding to the instructions. The computer-readable storage medium may be, for example, the memory 130.

A computer-readable recording medium may include a hard disk, a floppy disk, a magnetic medium (e.g., a magnetic tape), an optical medium (e.g., CD-ROM, digital versatile disc (DVD)), a magneto-optical medium (e.g., a floptical disk), or a hardware device (e.g., a ROM, a RAM, a flash memory, and the like). The program instructions may include machine language codes generated by compilers and high-level language codes that may be executed by computers using interpreters. The above-mentioned hardware device may be configured to be operated as one or more software modules for performing operations of various embodiments of the present disclosure and vice versa.

A module or a program module according to various embodiments of the present disclosure may include at least one of the above-mentioned elements, or some elements may be omitted or other additional elements may be added. Operations performed by the module, the program module or other elements according to various embodiments of the present disclosure may be performed in a sequential, parallel, iterative or heuristic way. Furthermore, some operations may be performed in another order or may be omitted, or other operations may be added.

Various embodiments of the present disclosure may provide an operation environment in which a desired content region may be obtained regardless of the type of content in response to a user's gesture.

The above embodiments of the present disclosure are illustrative and not limiting. Various alternatives and equivalents are possible. Other additions, subtractions, or modifications are obvious in view of the present disclosure and are intended to fall within the scope of the appended claims and their equivalents.

While the present disclosure has been shown and described with reference to embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a display;
a memory configured to store at least one piece of content; and
a processor electrically connected to the display and the memory,
wherein the processor is configured to receive input events sequentially input to a screen of the display, output a content, select a partial region of the content based on the input events within a specified time or at an interval, and display the partial region of the content different from a peripheral region of the screen.

2. The electronic device of claim 1, wherein the processor is further configured to output a capture guide including at least a portion of input locations corresponding to the received input events.

3. The electronic device of claim 2, wherein the processor is further configured to output the capture guide including the input locations corresponding to the received input events and at least one of a straight line and a curved line connecting adjacent input locations.

4. The electronic device of claim 2, wherein the processor is further configured to receive an additional input event related to a location change of at least one of the plurality of input events, and adjust a shape of the capture guide in response to the additional input event.

5. The electronic device of claim 1, wherein the processor is further configured to output, as a first capture guide, a figure including a location of a first input event and a location of a second input event input within a specified time at diagonally opposite corners.

6. The electronic device of claim 5, wherein the processor is further configured to output, if a third input event is received while the first capture guide is output, a second capture guide obtained by modifying the first capture guide such that at least a part of the figure corresponding to the first capture guide includes a location of the third input event.

7. The electronic device of claim 1, wherein the processor is further configured to output, as a second capture guide, a figure including a location of a first input event, a location of a second input event input within a specified time, and a location of a third input event at corner points.

8. The electronic device of claim 1, wherein the processor is further configured to output the partial region of the content to at least one of a popup window and a new window.

9. The electronic device of claim 1, wherein the processor is further configured to output the partial region of the content by enlarging the partial region of the content to a full screen.

10. The electronic device of claim 1, wherein the processor is further configured to output a capture guide corresponding to the plurality of received input events such that a type of the capture guide varies with a type of the content.

11. The electronic device of claim 1, wherein at least a portion of the input events comprise touching and holding the display.

12. A content region obtaining method comprising:
displaying content on a display;
receiving input events sequentially input to the display within a specified time; and
selecting a partial region of the content based on the received input events and displaying the selected partial region of the content different from a peripheral region of the selected partial content.

13. The content region obtaining method of claim 12, further comprising outputting a capture guide including at least a portion of input locations corresponding to the received input events.

14. The content region obtaining method of claim 13, wherein outputting the capture guide comprises outputting at least one of a straight line and a curved line connecting adjacent input locations.

15. The content region obtaining method of claim 13, further comprising:
receiving an additional input event related to a location change of at least one of the input events; and
adjusting a shape of the capture guide in response to the additional input event.

16. The content region obtaining method of claim 12, further comprising outputting, as a first capture guide, a figure including a location of a first input event and a location of a second input event input within a specified time at diagonally opposite corners.

17. The content region obtaining method of claim 16, further comprising outputting, if a third input event is received while the first capture guide is output, a second capture guide obtained by modifying the figure such that the figure includes an input location of the third input event.

18. The content region obtaining method of claim 12, further comprising outputting, as a second capture guide, a figure including a location of a first input event, a location of a second input event input within a specified time, and a location of a third input event at corner points.

19. The content region obtaining method of claim 12, wherein displaying content comprises at least one of outputting the obtained partial region of the content to a popup window, outputting the obtained partial region of the content to a new window, and expanding the obtained partial region of the content to a full screen.

20. The content region obtaining method of claim 12, further comprising:
determining a type of the content; and
outputting a capture guide corresponding to the received input events such that a type of the capture guide varies with the type of the content.
